(19) United States
(12) Patent Application Publication
(10) Pub. No.: US 2014/0104825 A1
(43) Pub. Date: Apr. 17, 2014

(54) Arrangement for Light Emission

(71) Applicants: Patrick Gassner, St. Gerold (AT); Michael Spiegel, Dornbirn (AT)

(72) Inventors: Patrick Gassner, St. Gerold (AT); Michael Spiegel, Dornbirn (AT)

(73) Assignee: Zumtobel Lighting GmbH, Dornbirn (AT)

(21) Appl. No.: 13/825,238

(22) PCT Filed: Sep. 26, 2011
(86) PCT No.: PCT/EP11/66634

§ 371 Date: May 7, 2013

(30) Foreign Application Priority Data
Sep. 27, 2010 (DE) 10 2010 041 477.8

(51) Int. Cl. F21K 99/00

(52) U.S. Cl. CPC F21K 9/17
USPC 362/223

(57) ABSTRACT

An arrangement for light emission has at least one LED light-emitting means (110) in an elongate arrangement, a support element (120), which supports the LED light-emitting means (110) and a light emission element (130) which can be connected to the support element (120). The light emission element (130) is designed to modify the light emission characteristic of the LED light-emitting means (110) to give the light emission characteristic of at least one fluorescent tube.

The subject matter of the application is an arrangement for light-emission having LED illuminants in an elongate arrangement, a carrier element which carries the LED illuminants, and a a light-radiating element which can be connected to the carrier element. Further subject matter of the application is a luminaire.

The optical capacity of LED light sources has undergone a development, making their use appear of interest for general lighting purposes. LED light sources are distinguished by their efficiency and, whilst provided the operating conditions are observed, by particular reliability. Their light-radiation characteristic as well as the operating conditions to be observed do, however, basically differ from those of conventional illuminants, such as, for example, incandescent bulbs, fluorescent tubes or gas-discharge lamps, so that it appears that existing luminaire constructions can only be retrofitted at considerable expense.

An object of the present invention is to provide an arrangement for light-emission which optimizes the outlay on retrofitting existing luminaire constructions.

This object is achieved with the features of claim 1. Further developments of the invention constitute subject matter of the dependent claims. An arrangement for light-emission in accordance with the invention has at least one LED illuminant in an elongate arrangement, a carrier element which carries the LED illuminant, and a light-radiating element which can be connected to the carrier element. The light-radiating element is formed to convert the light-radiation characteristic of the LED illuminant to the light-radiation characteristic of at least one fluorescent tube. Simple replacement of conventional fluorescent tubes by LEDs is thus possible without having to effect a complete new construction.

Basing considerations on the thought that the light-radiation characteristic and the position of installation of LEDs and conventional light sources differ for reasons of observance of the operating conditions for the respective illuminants, an arrangement is proposed for light-emission that has LED illuminants in an elongate arrangement, a carrier element which carries the LED illuminants, and a light-radiating element which can be connected to the carrier element.

It is provided in this connection that the light-radiating element radiates incident radiation of the LED illuminants over a light-emission area so that adaptation of the light-radiation characteristic can be carried out by way of the form of the light-radiating element. An elongate arrangement of the LED illuminants assists the approximation to the light-radiation characteristic of a fluorescent tube. A plurality of LEDs that admittedly preferably belong to the same type class can be used as illuminants, although the invention is not limited thereto in the least. For example, LEDs with different power characteristics or colour radiation can be used.

The light-radiating element is preferably formed to simulate the light-radiation characteristic of an arrangement of fluorescent tubes. In a further development of the invention it is provided that the light-radiating element is formed as a diffuser. This renders possible, starting from the surface, uniform illumination of larger areas.

Simulation of the light-radiation characteristic of an arrangement of a plurality of fluorescent tubes is also possible. Typically, the close arrangement of two fluorescent tubes side by side is replaced thus.

The invention is described by way of example in the following with reference to the drawings in which an advantageous exemplary embodiment of the invention is presented and in which:

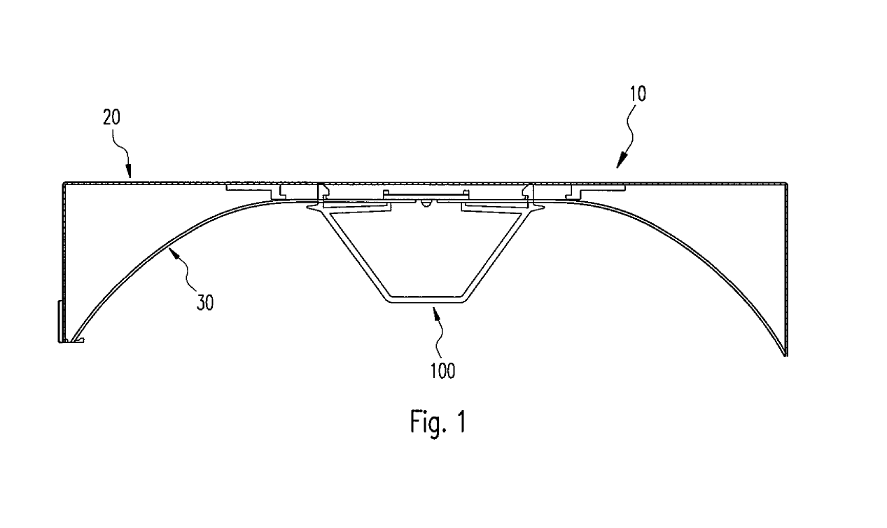

FIG. 1 shows an exemplary embodiment of the arrangement in accordance with the invention; and

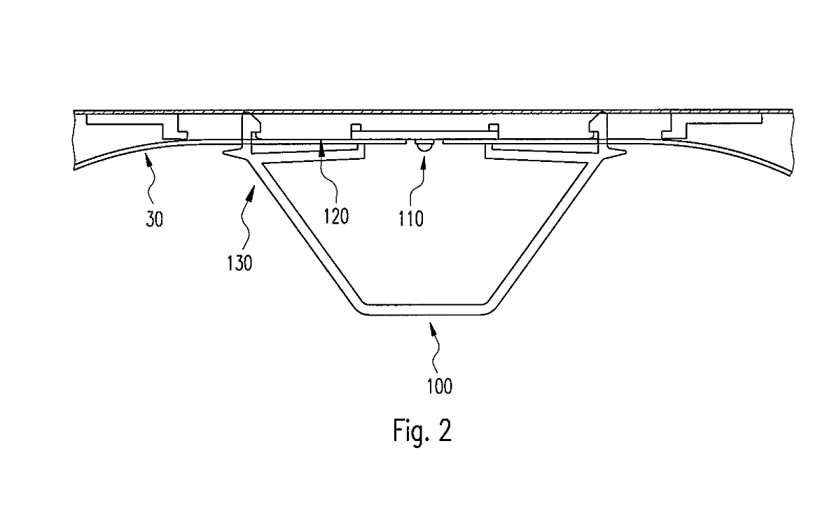

FIG. 2 shows a detailed view of the exemplary embodiment of the arrangement in accordance with the invention.

In the first instance, the general structure of the luminaire in accordance with the invention is explained with reference to FIG. 1. Subsequently, the precise technical structure and the mode of functioning of the luminaire in accordance with the invention and the arrangement for light-emission in accordance with the invention are presented with reference to FIG. 2. Identical elements have in part not been repeatedly presented and described in figures that are similar.

FIG. 1 shows an exemplary embodiment of a luminaire 10 in accordance with the invention in a sectional representation. The luminaire 10 in accordance with the invention in this case contains a housing 20, a reflector 30 and an arrangement for light-emission 100. With its closed side, the upper side in the drawing, the housing 20 can in this case be secured to a surface, for example a ceiling. The light-emission is effected through the arrangement for light-emission 100 in the opposite direction. The reflector 30 then reflects a portion of the luminous power emitted by the arrangement for light-emission 100.

The reflector 30 is in this case set up with a curved form, in particular a parabolic form. Uniform illumination of a region that is controllable in a targeted manner is thus achieved. The reflector 30 in this case ends so as to be flush with the housing 20 of the luminaire 10. The reflector 30 is provided with a focal point in the sectional representation. In three-dimensional reality, this is not a focal point, but a focal line. The focal point largely corresponds, at least in sections, with the outer surface of the light-radiating element 130, or rather sections of the limiting face of the light-radiating element 130 correspond with the focal point. Optimum distribution of the light that is radiated by the light-radiating element 130 through the reflector 30 is thus achieved.

The arrangement for light-emission 100, which is shown in greater detail in FIG. 2, contains a carrier element 120, an LED illuminant 110 and a light-radiating element 130. The carrier element 120 is in this case connected to the housing 20 of the luminaire 10. The carrier element 120 carries, furthermore, the LED illuminant 110. Alternatively, a plurality of LED illuminants 110 can also be secured to the carrier element 120. The LED illuminant 110 is preferably reversibly connected to the carrier element 120 and can be connected or separated without the use of a tool. The LED illuminant 110 is arranged in such a way that the light-radiation is effected in the direction of the open side of the housing. Arranged between the LED illuminant 110 and the open side of the housing there is, furthermore, the light-radiating element 130. In this case, it is connected to the carrier element 120 and held by it. Advantageously, this connection is reversible and can be effected and released without the use of a tool. Instead of being connected merely to the housing 20, the carrier element 120 can complete the surface of the housing 20 that is interrupted by an opening. It is thus possible to make savings in terms of material for the housing.

The reflector 30 is likewise connected to the carrier element 120. In the case of a conventional luminaire, one or more fluorescent tubes would be located at the focal point of the reflector 30. These would be arranged perpendicularly with respect to the sectional plane of the drawings. The light-radiating element 130 is formed here in such a way that its outer form largely corresponds to the contour of the fluorescent tube or fluorescent tubes in a conventional luminaire. The light-radiating element 130 thus converts the light-radiation characteristic of the LED illuminant 110 to the light-radiation characteristic of at least one fluorescent tube.

For this, the light-radiating element 130 is formed as a diffuser. In other words, hard light is turned into soft diffused light. Thus a virtual light source is generated at the position of the outer surface of the light-radiating element 130. This virtual light source has the radiation characteristic of one or more fluorescent tubes. Individual LED illuminants are no longer discernible. Advantageously, the light-radiating element 130 is produced from diffuse plastics material.

The light-radiating element 130 in this connection is a profiled body with a substantially trapezoidal cross section. It is aligned in this case along the replaced fluorescent tube and thus along the LED illuminant 110. The light-radiating element 130 then extends over the whole length of the LED illuminants 110. The limiting faces of the light-radiating element 130 in sections correspond substantially with a surface form of one or more fluorescent tubes that can be arranged between the carrier element 120 and the light-radiating element 130.

The reflector 30 projects into the region of the light-radiating element 130. In other words, the reflector 30 and the light-radiating element 130 overlap in part. The reflector 30 has a first light-radiation characteristic outside the light-radiating element 130. In the region inside the light-radiating element 130, the reflector has a second light-radiation characteristic. As a result, the whole light-radiation characteristic of the luminaire 10 can be adjusted further.

Advantageously, moreover, the surface of the carrier element 120 that is directed in the direction of the light-radiation is provided with a coating of high reflectivity. A further increase in the degree of efficiency of the luminaire can thus be attained.

The luminaire 10 is provided, furthermore, with a light-exit opening. The light-exit opening is in this case advantageously provided with a cover which is not shown here. The cover is divided into a plurality of sections. In the vicinity of the light-radiating element 130 the cover is provided with a first light-radiation characteristic. In the region close to the edge of the luminaire 10, that is, remote from the light-radiating element 130, the cover is provided with a second light-radiation characteristic. Thus further fine adjustment of the light quality can be effected in the various regions that are to be illuminated. For example, diffuse, very uniform illumination is possible in the region of the light-radiating element 130 directly in the direction of the light-exit opening of the luminaire, whilst in the lateral region, that is, to the side of the direct direction of radiation, illumination that is less diffuse is achieved with at the same time a higher degree of efficiency on account of lower losses as a result of the diffuser.

The invention is not limited to the exemplary embodiment shown. Profiles of the light-radiating element that deviate therefrom are also conceivable. Use without a reflector is within the inventive idea. All of the features described above or features shown in the figures can be combined with each other advantageously in any way within the scope of the invention.

1. An arrangement for light-emission (100), having
at least one LED illuminant (110) in an elongate arrangement,
a carrier element (120), which carries the LED illuminants, and
a light-radiating element (130), which can be connected to the carrier element, characterised in that the light-radiating element (130) is formed to convert the light-radiation characteristic of the LED illuminant (110) to the light-radiation characteristic of at least one fluorescent tube.

2. An arrangement for light-emission according to claim 1, characterised in that the light-radiating element (130) is formed as a diffuser.

3. An arrangement for light-emission according to claim 1, characterised in that the light-radiating element (130) is formed as a profiled body with a substantially trapezoidal cross section in a cross-sectional plane, in that a normal of the cross-sectional plane corresponds to the longitudinal direction of the LED illuminant.

4. An arrangement for light-emission according to claim 1, characterised in that the carrier element (120) and the light-radiating element (130) are connected in a reversibly releasable manner, and in that the carrier element (120) and the light-radiating element (130) are preferably connectable and releasable without a tool.

5. An arrangement for light-emission according to claims 1, characterised in that the carrier element (120) is reversibly connectable to an illuminant-carrier, in that the illuminant-carrier is an LED printed circuit board, and in that the carrier element (120) and the illuminant-carrier are preferably connectable and releasable without a tool.

6. An arrangement for light-emission according to claim 1, characterised in that limiting faces of the light-radiating element (130) in sections corresponds substantially with a surface form of one or more fluorescent tubes that can be arranged between the carrier element (120) and the light-radiating element (130).

7. A luminaire (10) having
a housing (20),
a light-exit opening (30), fixed by the housing (20), and also an arrangement for light-emission according to claim 1.

8. A luminaire having according to claim 7, characterised in that the carrier element (120) is connected directly to the housing (20) and/or completes a wall of the housing (20).

9. A luminaire according to claim 7, characterised in that the carrier element (120) is connected to the housing (20) in a reversibly releasable manner, and in that the carrier element (120) and the housing (20) are preferably connectable and releasable without a tool.

10. A luminaire according claim 7, characterised in that the luminaire (10) has a reflector (40) which preferably has at least one focal point in a cross-sectional representation, and in that sections of the limiting face of the light-radiating element (130) preferably correspond with the focal point.

11. A luminaire according to claim 10, characterised in that the carrier element (120) is reflective in the region of the light-radiating element (130), in that the reflector (30) borders directly on the carrier element (120), in that the reflector (30) is connected to the carrier element (120), and in that the reflector (30) and the carrier element (120) are preferably reversibly connectable and releasable without a tool.

12. A luminaire according to claim 10, characterised in that at least a first portion of the reflector (30) is arranged between the carrier element (120) and the light-radiating element (130), in that at least a second portion of the reflector (30) is not arranged between the carrier element (120) and the light-radiating element (130), and in that preferably the first portion of the reflector (30) and the second portion of the reflector (30) have different radiation characteristics.

13. A luminaire according to claim 7, characterised in that the luminaire (10) has a cover of the light-exit opening arranged downstream of the light-radiating element (130) in the optical path, in that the cover has a central region close to the light-radiating element (130), in that the cover has a lateral region further away from the light-radiating element (130), and in that the cover has different light-radiation characteristics in the lateral region and in the central region.
